(19) United States
(12) Patent Application Publication
(10) Pub. No.: US 2003/0194485 A1
(43) Pub. Date: Oct. 16, 2003

(54) Alloy plating solution for surface treatment of modular printed circuit board

(76) Inventors: Byoung-Ho Rhee, Daejeon (KR); Dek-Gin Yang, Chungbuk (KR); Dong-Gi An, Chungnam (KR); Chul-Min Lee, Chungnam (KR); Tae-Kyu Kwak, Chungbuk (KR); Sung-Yong Her, Seoul (KR); Sung-Wook Chun, Inchon (KR); Myong-Chul Shin, Seoul (KR); Sang-Wook Chun, Inchon (KR)

Correspondence Address: GOTTLIEB RACKMAN & REISMAN PC, 270 MADISON AVENUE, 8TH FLOOR, NEW YORK, NY, 100160601

(21) Appl. No.: 10/409,440

(22) Filed: Apr. 7, 2003

(30) Foreign Application Priority Data
Apr. 9, 2002 (KR) 2002-19235

(51) Int. Cl. B05D 1/36; B05D 5/12; B05D 1/18; C23C 18/31

(52) U.S. Cl. 427/98; 427/437; 427/404; 106/1.23; 106/1.26

(57) ABSTRACT

Disclosed is an aqueous alloy plating solution for surface treatment of a modular PCB. The plating solution comprises 1-30 wt % of an organic acid having at least one sulfonic acid group (—SO₃H), 0.1-20 wt % of a complexing agent, 0.1-15 wt % of a thio-compound having at least one —S—, 0.05-5 wt % of a water soluble gold compound, 0.001-1 wt % of a water soluble silver compound and 0.1-10 wt % of a sequestering agent, based upon the weight of the plating solution. According to this invention, all plating properties required for the modular PCB are obtained through a single plating process, instead of the conventional double plating process.

### BACKGROUND OF THE INVENTION

1. Field of the Invention

The present invention pertains to gold-silver alloy plating solution compositions, applicable for surface treatment of a modular printed circuit board (hereinafter, referred to a modular PCB) for mounting parts. More specifically, the present invention pertains to a gold-silver alloy plating solution, which forms an alloy plated layer comprising 90-99% gold and 1-10% silver by electroless plating a nickel on a pad portion and a tab portion of the modular PCB and then immersion plating the nickel-plated surface of the modular PCB with the gold-silver alloy plating solution.

2. Description of the Prior Art

Generally, a modular PCB comprises circuit patterns, a pad portion for electronic parts, and a tab portion for electrically connecting to an exterior device by a detachment and an attachment manner on a board. Typically, the circuit patterns, the pad portion and the tab portion are made of copper. In this regard, a photograph showing a top view of the PCB in a strip form is shown in FIG. 1. However, the externally exposed copper layer tends to be oxidized over time and thus reliability is decreased upon mounting of electronic parts such as a semiconductor. As surface treatment for preventing such a phenomenon, soft gold electroless plating is conducted on both of the pad portion 2 and the tab portion 3, and then only on the tab portion 3, hard gold electroplating is additionally performed. Typically, the gold electroless plating is widely known in this art. For instance, in Korean Patent Laid-open Publication No. 2000-53621, there is disclosed a method for preparing a printed circuit board by forming a nickel electroless plating layer on a copper portion to be gold-plated by use of a photo solder resist (PSR), followed by dipping the surface of the nickel layer in a gold plating solution comprising at least one water-soluble gold compound, at least one organic conductive salt, at least one reducing agent and water. In Japanese Patent Laid-open Publication No. Hei. 7-7243, there is also disclosed a method for electroless gold plating comprising the steps of forming a first amorphous electroless nickel coating on a copper portion to be gold-plated, forming a second crystalline electroless nickel coating on the first nickel coating, and forming an electroless gold plating coating on the second nickel coating through a replacement/exchange reaction as a main reaction. In addition, U.S. Pat. Nos. 5,173,130 and 5,235,139 disclose an improved technique for forming a nickel-gold plated layer on a copper layer.

The reason why only the tab portion in the modular PCB is subjected to hard gold electroplating is as follows.

In the case of forming only a soft gold plated layer after formation of the electroless nickel plated layer, solderability to the pad portion and the tab portion in the modular PCB is good, but scratches are generated due to insufficient abrasion resistance of the tab portion, thus causing erosion of the nickel layer exposed by the scratches. Meanwhile, in the case of forming only a hard gold plated layer after formation of the electroless nickel plated layer, abrasion resistance of the pad portion and the tab portion in the modular PCB is good, however, spreadability of the solder paste becomes insufficient and dewetting is caused upon mounting owing to lowered solderability.

Accordingly, in the preparation of such modular PCB, the pad portion for mounting parts has solderability by the soft gold electroless plated layer formed thereon, and the tab portion which is repeatedly detached and attached has abrasion resistance by the hard gold electroplated layer additionally formed on the soft gold electroless plated layer.

Referring to FIG. 2, there is schematically shown one embodiment of the modular PCB, subjected to the conventional gold plating process.

According to the method widely known in this art, on a board 1, a patterned circuit (not shown), a pad portion 2 and a tab portion 3 are formed, and a photo solder resist layer 4 is formed onto the remaining portions except for the portions (pad portion and tab portion) to be gold-plated. Then, the pad portion and the tab portion are treated with an electroless nickel plating solution at about 85° C. for about 20 minutes, on which a nickel plated layer 5 having a thickness of about 3-6 μm and containing about 5-8% of phosphorous is formed.

Thereafter, the surface of the nickel plated layer is immersed in a gold plating solution containing citric acid as a main ingredient, to firm a soft electroless gold plated layer 6 about 0.1 μm thick thereon.

After the soft gold plated layer 6 is formed onto the pad portion and the tab portion, the pad portion is masked with dry film (or photo resist) having resistance to the plating solution during the subsequent hard gold plating process. The hard gold electroplated layer 7 being about 1 μm in thickness is formed onto only the tab portion, and then dry film is removed from the pad portion.

However, the above conventional method of surface treating the modular PCB suffers from the disadvantages of low economic benefit and poor productivity due to complicated processes requiring the additional steps of exposure, development and delamination of dry film during the hard gold plating process.

### SUMMARY OF THE INVENTION

Leading to the present invention, the intensive and thorough research for surface treatment of a modular PCB, carried out by the present inventors aiming to avoid the problems encountered in the prior arts, resulted in the finding that, when a novel gold-silver alloy plating solution is used, properties required for each of a pad portion and a tab portion in the modular PCB can be obtained at the same time.

Therefore, it is an object of the present invention to provide an aqueous electroless gold-silver alloy plating solution, which can provide all plating properties required for each of a pad portion and a tab portion of the modular PCB through a single plating process.

It is another object of the present invention to provide an aqueous electroless gold-silver alloy plating solution, which is advantageous in light of simplified process, improved productivity and lowered cost, since a double plating process of a soft gold electroless plating and a hard gold electroplating, which has been performed in the conventional surface treatment of the modular PCB, can be replaced with a single plating process.

It is a further object of the present invention to provide a method for surface treating a modular printed circuit board by use of the electroless alloy plating solution as above.

In accordance with an embodiment of the present invention, there is provided an aqueous electroless plating solution for surface treatment of a modular PCB comprising 1-30 wt % of an organic acid having at least one sulfonic acid group (—SO₃H), 0.1-20 wt % of a completing agent, 0.1-15 wt % of a thio-compound having at least one —S—, 0.05-5 wt % of a water soluble gold compound, 0.001-1 wt % of a water soluble silver compound and 0.1-10 wt % of a sequestering agent, on the basis of the weight of the plating solution.

In accordance with another embodiment of the present invention, there is provided a method for plating a modular printed circuit board, comprising the following steps of: a) providing a modular printed circuit board formed with predetermined circuit patterns, having a pad portion for mounting parts and a tab portion for electrically connecting to an exterior device; b) forming a photo solder resist layer onto the remaining portions exclusive of the pad portion and the tab portion in the printed circuit board; c) forming an electroless nickel plated layer on the pad portion and the tab portion; and d) immersing the surface of the nickel plated layer in said aqueous electroless alloy plating solution, to form a gold-silver alloy plated layer thereon.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a photograph showing a top view of a modular printed circuit board in a strip form.

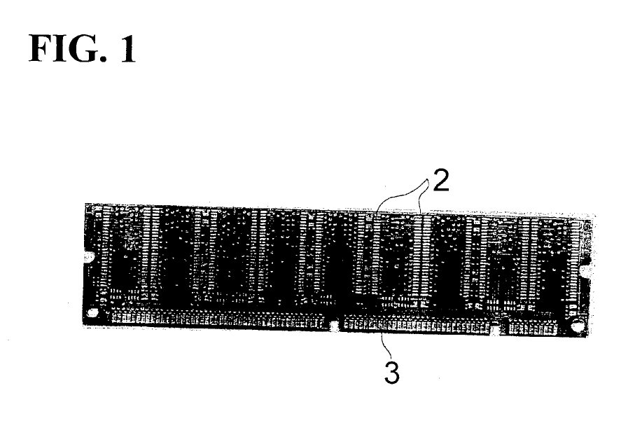

FIG. 2 is a schematic diagram showing a plating process of the conventional modular printed circuit board.

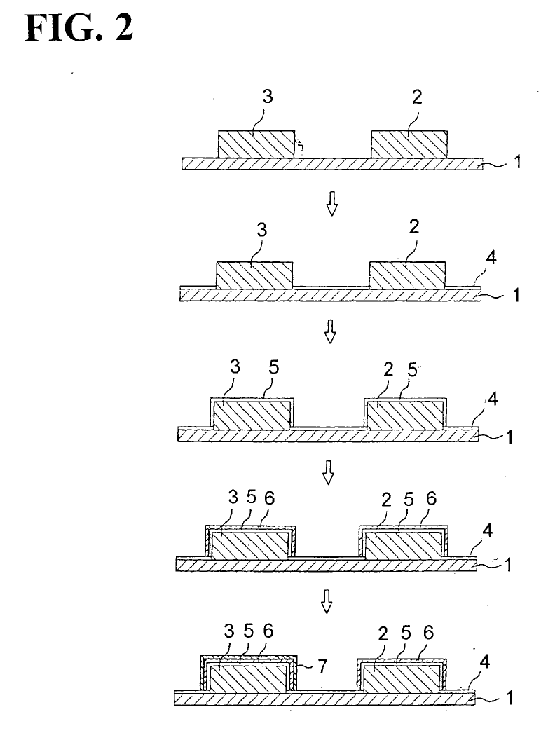

FIG. 3 is a schematic diagram showing a plating process of a modular printed circuit board according to one embodiment of the present invention.

### DETAILED DESCRIPTION OF THE INVENTION

The present invention is directed to an aqueous electroless gold-silver alloy plating solution, capable of substituting a single plating process for the conventional double plating process comprising a soft gold electroless plating process and a hard gold electroplating process. An alloy plated layer obtained as a gold and silver eutectoid layer can provide solderability to a pad portion for mounting parts, as well as excellent abrasion resistance to a tab portion, respectively, whereby the advantages of the double plating process can be obtained at the same time.

The aqueous electroless gold-silver plating solution according to the present invention comprises an organic acid, a complexing agent, a thio-compound, a water soluble gold compound, a water soluble silver compound and a sequestering agent. A plating principle of the plating solution is briefly described as follows.

Before plating, an electroless nickel plated layer over the pad portion and the tab portion on the modular printed circuit board is formed. Based on the principle in which the organic acid in the plating solution partly dissolves the nickel (Ni) layer and the gold and silver ions complexed by the complexing agent under the aqueous condition are deposited to form a gold-silver alloy layer on the nickel layer by potential difference, the plating process is conducted.

In the present invention, the organic acid having at least one sulfonic acid group (—SO₃H) may be selected from the group consisting of methane sulfonic acid, methane disulfonic acid, sulfo salicylic acid, phenol sulfonic acid, amido sulfonic acid, dodecyl benzene sulfonic acid and combinations thereof. Such organic acid is added in the amount of about 1-30 wt %, and preferably, in the amount of about 3-10 wt %, on a basis of the weight of the plating solution. If the amount is less than 1 wt %, the nickel layer is not sufficiently dissolved, thus formation of the gold-silver alloy plated layer is difficult. On the other hand, if the amount exceeds 30 wt %, the nickel layer is excessively dissolved to deteriorate the properties of the resultant alloy plated layer.

The complexing agent can be selected from the group consisting of cyanides of alkali metals, such as sodium cyanide and potassium cyanide, cyanides of alkali earth metals, potassium ferricyanide, potassium ferrocyanide, and combinations thereof. The complexing agent is used in the amount of about 0.1-20 wt %, and preferably, in the amount of about 0.1-15 wt %, based on the weight of the plating solution. When the amount is less than 0.1 wt %, the complexing extent of gold and silver ions becomes low, and thus an alloy ratio of gold and silver in the plated layer is not constantly maintained. On the other hand, if the amount exceeds 20 wt %, concentrations of gold and silver ions can be increased in the plating solution thanks to the improvement of stability thereof, but loss of the gold and silver ions which do not participate in plating is problematic. Preferably, a molar ratio of the total gold and silver ions versus the cyanide of the complexing agent is in the range of from about 1:1 to about 1:5.

The thio-compound serves to stabilize the gold and silver ions in the aqueous plating solution, and have at least one —SO— therein. Examples of such a thio-compound are thiourea, alkylthiourea, mercapto compounds, thioglycolic acid, sodium thiocyanide, ammonium thiocyanide and so on. The thio compound can be used alone or in combinations thereof, and is used in the amount of about 0.1-15 wt %, and preferably, in the amount of about 0.5-5 wt %, based on the weight of the plating solution. An amount less than 0.1 wt % results in instability of the aqueous solution, while an amount exceeding 15 wt % leads to deposition of the thio-compound according to the solubility thereof.

The sequestering agent serves to chelate Ni and Cu components dissolved during the plating process, and may be selected from the group consisting of polycarboxylic acid derivatives, amino acetic acid derivatives, nitrilo-triacetic acid derivatives and the combinations thereof. Examples of suitable sequestering agent are ethylene diamine tetra acetic acid, diethylene triamine penta-acetic acid, N-hydroxyethylethylene diamine triacetic acid, 1,3-diamino-2-propanol-N,N,N,N′-tetra acetic acid, bishydroxyphenyl-ethylene, diamine diacetic acid, N,N-di(hydroxyethyl) glycine, and so forth. The sequestering agent is used in the amount of about 0.1-10 wt %, and preferably, in the amount of about 0.5-5 wt %, based upon the weight of the plating solution.

As a source of gold ions, a water-soluble gold compound includes, but is not limited to, potassium gold cyanide and potassium gold chloride. Such compounds are used alone or in combinations thereof. Said water-soluble gold compound is used in the amount of about 0.05-5 wt %, and preferably, in the amount of about 0.1-1 wt %, based on the weight of the plating solution.

As a source of silver ion, any water soluble silver compound may be used. Suitable examples may include silver nitrate, silver cyanide, potassium silver cyanide, silver acetate, silver carbonate or combinations thereof. Said water soluble silver compound is used in the amount of about 0.001-1 wt %, and preferably, in the amount of about 0.02-0.2 wt %, based on the weight of the plating solution. In the present invention, the ratio of gold and silver in the gold-silver plated layer plays an important role in showing desirable plating properties. So, it is preferred that the water soluble silver compound is adjusted to be present within the range of about 3-8 wt % of the water soluble gold compound in the plating solution.

In the present invention, pH of the plating solution is about 3-7, preferably, about 4-5. A temperature required for plating process ranges within about 60-90° C., and preferably, about 70-80° C.

The aqueous electroless gold-silver plating solution as prepared above is used to form an alloy plated layer over the electroless nickel plated layer on the modular printed circuit board, comprising about 90-99% gold and about 1-10% silver. If the gold content is less than said range, solderability becomes insufficient. On the other hand, if the gold content exceeds said range, the reproductivity is deteriorated due to the excessive spread of the solder upon mounting.

Further, the alloy plated layer is typically about 0.01-0.25 μm thick. The fact that the plated layer having thickness below or above said range can be formed by varying process conditions, if necessary, can be understood to those skilled in the art. Typically, plating for formation of a gold-silver alloy plated layer required for mounting parts on the modular PCB is carried out for about 5-15 minutes in the present invention.

In order to achieve desirable properties of the plated layers on the modular PCB, pre-treatment may be optionally conducted in the process of plating. For example, both the pad portion and the tab portion made of copper are subjected to mechanical polishing, thus eliminating impurities on the surface, followed by chemically removing organic matters. Further, it is preferred that the surface of the copper layer is etched and then optionally treated with palladium (Pd) as a catalyst, before formation of the nickel plated layer.

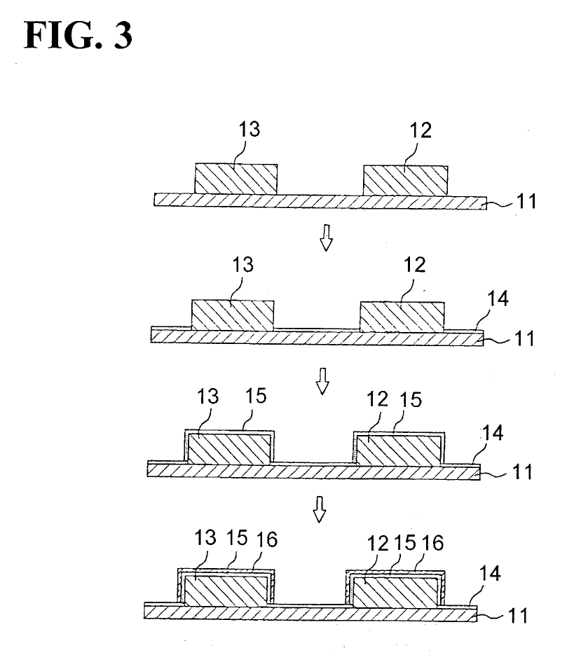

A method for plating the modular PCB with the use of the plating solution of the present invention is schematically shown in FIG. 3.

On the board 11 equipped with a pad portion 12 for mounting parts and a tab portion 13 for connecting electrically to an exterior device, a predetermined circuit pattern (not shown) is formed through a photolithography process known widely in the art.

Then, a photo solder resist (PSR) layer 14, responsible for resist to the plating solution during the plating process, is applied onto the printed circuit board 11. On the solder resist layer 14 is applied dry film, and then only the portion of the solder resist layer on both of the pad portion 12 and the tab portion 13 is selectively delaminated through exposure and development.

Thereafter, the pad portion 12 and the tab portion 13 are externally exposed, on which an electroless nickel plated layer 15 is formed. A specific process for formation of such electroless nickel plated layer is as described above.

With a view to prevention of damage of the nickel plated layer 15 formed on the pad portion and the tab portion, provided is a gold-silver alloy plated layer 16 by immersing the surface of the nickel plated layer in the aqueous electroless plating solution according to the present invention for a sufficient time period.

A better understanding of the present invention may be obtained in light of the following examples which are set forth to illustrate, but are not to be construed to limit the present invention.

In the following examples, the modular PCB (board size: 340×510 mm, board thickness: 0.80±0.08 mm, copper layer thickness: 30-50 μm) formed with a photo solder resist layer (ST-2 ink, supplied from Dong Hwa Tamura Kaken Co., LTD), exclusive of the pad portion and the tab portion made of copper, was degreased with an acid (sulfuric acid concentration: 160-200 g/l) at 50° C. for 3 minutes, catalyzed with palladium (cata 1845, supplied from Yuil Tech Co., Ltd), washed with water, and plated with an electroless nickel plating solution (EN-1845, supplied from Yuil Tech Co., Ltd) at 85° C. for 20 minutes. As such, the electroless nickel layer formed on the pad portion and the tab portion was 4.7 μm thick.

As described above, the nickel layer-formed modular PCB was washed with water, activation-treated in 3% hydrochloric acid solution at 25° C. for 1 minute, and again washed with water. Then, a gold-silver alloy plating process was conducted on the nickel layer, as stated below.

### EXAMPLE 1

An aqueous alloy plating solution of the composition shown in the following Table 1 was prepared, and then the electroless nickel plated modular PCB was activation-treated with 3% hydrochloric acid solution at 25° C. for 1 minute. While adjusting the temperatures of three plating solution baths to each of 60° C., 70° C. and 80° C., the PCB was dipped in the plating solutions for 10 minutes and plated. As such, the plating solutions were not stirred and pH of the plating solutions was 4.5.

TABLE 1
Composition of Plating Solution

| Component | Content | |
|---|---|---|
| Methane Sulfonic acid | 30 | g/l |
| Sodium Cyanide | 10 | g/l |
| Thiourea | 10 | g/l |
| Silver Nitrate | 0.25 | g/l |
| Potassium Gold Cyanide | 5 | g/l |
| Nitrilo Acetic Acid | 3 | g/l |

After the plating process, the boards were washed with water, dried at 80° C. for 15 minutes, and then measured for solderability and abrasion resistance by the following condition and method.

Solderability

The pad portion was printed with a solder paste having a size of 0.04 mm (average particle size).

Reflow condition: 160° C.-190° C.-245° C.-90° C. (rate: 1.0 m/min)

Evaluating Method

To evaluate the solderability, solder paste having a Sn:Pb ratio of 63:37 were superimposed on the pad portion. Thereafter, when the solder paste on the pad portion was heated under the reflow condition, the solder paste having a melting point of 183° C. was melted and spread on the pad portion. Solderability can be evaluated in view of the spread area of the solder paste. That is, the larger the spread area, the more excellent the solderability.

Evaluating Standard

Solderability (after reflow): normal when the solder paste particle size is three times or more (0.12 mm or larger) than the initial particle size.

Abrasion Resistance

Clip test: a clip was repeatedly attached to and detached from the tab portion of the modular PCB over 100 times, and then it was observed with an electron microscope whether the nickel layer formed under the alloy plated layer was exposed.

Test results for solderability of the pad portion and abrasion resistance of the tab portion are given in Table 2, below.

TABLE 2

| | Temperature | | | |
|---|---|---|---|---|
| | 60° C. | 70° C. | 80° C. | Note |
| Alloy Ratio of Gold:Silver | 94:6 | 94:6 | 94:6 | |
| Solder Spreadability (mm) | 0.138 | 0.135 | 0.131 | |
| Abrasion Resistance (clip) | Normal | Normal | Normal | 100 times |

### EXAMPLE 2

An aqueous alloy plating solution of the composition shown in the following Table 3 was prepared, and then the electroless nickel plated modular PCB was activation-treated with 3% hydrochloric acid solution at 25° C. for 1 minute. At time periods for plating of 5 minutes, 10 minutes and 15 minutes, the plating process was carried out by use of the plating solution of 80° C. As such, the plating solution was not stirred and pH of the plating solution was 4.5.

TABLE 3
Composition of Plating Solution

| Component | Content | |
|---|---|---|
| Methane Sulfonic acid | 50 | g/l |
| Potassium Cyanide | 10 | g/l |
| Thioglycolic Acid | 10 | g/l |
| Silver Nitrate | 0.25 | g/l |
| Potassium Gold Cyanide | 5 | g/l |
| Nitrilo Acetic Acid | 3 | g/l |

Then, the post-treatment was conducted in the same manner as in Example 1, and solderability and abrasion resistance were measured. The results are presented in Table 4, below.

TABLE 4

| | Time Period | | | |
|---|---|---|---|---|
| | 5 min. | 10 min. | 15 min. | Note |
| Alloy Ratio of Gold:Silver | 92:3 | 92:3 | 92:8 | |
| Solder Spreadability (mm) | 0.126 | 0.125 | 0.122 | |
| Abrasion Resistance (clip) | Normal | Normal | Normal | 100 times |

### EXAMPLE 3

An aqueous alloy plating solution having the composition of the following Table 5 was prepared, and then the electroless nickel plated modular PCB was activation-treated with 3% hydrochloric acid solution at 25° C. for 1 minute. Then, the plating process was performed for 10 minutes using the plating solution of 80° C., under stirring conditions of 0.1 m/s, 0.2 m/s and 0.3 m/s.

TABLE 5
Composition of Plating Solution

| Component | Content | |
|---|---|---|
| Methane Sulfonic acid | 40 | g/l |
| Potassium Cyanide | 6 | g/l |
| Methylthiourea | 1.5 | g/l |
| Silver Cyanide | 0.1 | g/l |
| Potassium Gold Cyanide | 2.5 | g/l |
| DTPA-5Na | 3 | g/l |

Then, post-treatment was conducted in the same manner as in Example 1, and solderability and abrasion resistance were measured. The results are presented in Table 6, below.

TABLE 6

| | Stirring | | | |
|---|---|---|---|---|
| | 0.1 m/s | 0.2 m/s | 0.3 m/s | Note |
| Alloy Ratio of Gold:Silver | 96:4 | 96:4 | 96:4 | |
| Solder Spreadability (mm) | 0.149 | 0.146 | 0.145 | |
| Abrasion Resistance (clip) | Normal | Normal | Normal | 100 times |

### EXAMPLE 4

On the modular printed circuit board used in Example 1, the pad portion and the tab portion were plated at 85° C. for 20 minutes using an electroless nickel plating solution (EN-1845, supplied from Yuil Tech Co., Ltd). The electroless nickel layer on both of the pad portion and the tab portion was 4.7 μm thick. Thereafter, using the plating solution prepared in Example 3, alloy plating was carried out on the nickel plated layer at 80° C. for 10 minutes. Reliability for thus plated modular PCB was evaluated according to a reliability evaluation standard with respect to PCB surface treatment of Samsung Electro-Mechanics.

Measurement of Plated Thickness

To confirm whether the gold-silver alloy plated products have a thickness desired in the present invention, thickness of both the nickel plated layer and the gold-silver alloy plated layer was measured by use of a thickness gauge (CMI 900, supplied from CMI).

Porosity Test

The plated modular PCB was immersed in an aqueous HNO₃, and it was observed with the naked eye for pore formation of the gold-silver alloy plated surface due to erosion.

Heat Resistance Test

The gold-silver alloy plated product was passed through 3 cycles of IR-reflow under temperature conditions mentioned in the following Table 7. Thereafter, discoloration of the plated layer by heat and the separation of the gold-silver alloy plated layer from nickel plated layer by use of an adhesion tape, were examined.

Solderability Test

Under two conditions described in the following Table 7, the pad portion was dipped into the molten solder and then whether the pad portion was wetted by the solder to a level of 95% or more was observed.

Adhesiveness Test

Under temperature conditions described in the following Table 7, the plated product was passed through 3 cycles of IR-reflow, and then an aluminum wire was soldered to the pad portion. When the aluminum wire was drawn under the predetermined force, it was observed for the separation of the gold-silver alloy plated layer from the nickel plated layer. Further, whether the solder and the gold-silver alloy plated layer were separated from each other, was checked.

TABLE 7

| | | | Test |
|---|---|---|---|
| Test | Standard Condition | Test Process | Result |
| Thickness of | Au—Ag layer: | X-ray thickness gauge | O |
| Au—Ag | Min. 0.05 μm | (CMI 900, CMI) | |
| layer and | Ni layer | | |
| Ni layer | Min. 2.00 μm | | |
| Porosity | No erosion of | Immersion in 12% HNO₃ | O |
| | Au—Ag layer | for 15 min. | |
| Heat | No discoloration | Tape peel test after | O |
| Resistance | by heat, and no | continuously passing | |
| | delamination of | through 3 cycles of IR- | |
| | Au—Ag layer by | reflow | |
| | the tape peel test, | Speed: 240 rpm | |
| | | Temp.: 220, 240, 270, | |
| | | 230° C. | |
| Solderability | | | |
| Condition 1 | Wettability of 95% | Immersion in solder of | O |
| | or more | 230° C. for 3 sec. 1 cycle | |
| Condition 2 | Wettability of 95% | After hydrating in boiling | O |
| | or more | water for 1 hr., dipping | |
| | | in solder of 230° C. for | |
| | | 3 sec. 1 cycle | |
| Adhesiveness | Delamination of Cu | Drawing aluminum wire | O |
| | layer and epoxy | after continuously | |
| | interface | passing through 3 cycles | |
| | | of IR-reflow | |

Note)
O: means that the test result fulfills the predetermined standard condition.

From the test results, it can be seen that all plated properties provided by the alloy plated layer according to the present invention are satisfactory.

Therefore, the aqueous electroless gold-silver alloy plating solution according to the present invention meets the plating properties required for each of the pad portion and the tab portion in the modular PCB. Also, in the present invention, the conventional double plating process comprising a soft gold electroless plating and a hard gold electroplating can be replaced with a single plating process. Thereby, there are advantages such as simplified process, improved productivity and lowered preparation cost. In particular, the inventive plating solution can be applied to all modular PCB used for mounting semiconductors.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. Aqueous electroless plating solution for surface treatment of a modular PCB, comprising 1-30 wt % of an organic acid having at least one sulfonic acid group (—SO₃H), 0.1-20 wt % of a complexing agent, 0.1-15 wt % of a thio-compound having at least one —S—, 0.05-5 wt % of a water soluble gold compound, 0.001-1 wt % of a water soluble silver compound and 0.1-10 wt % of a sequestering agent, on the basis of the weight of the plating solution.

2. The plating solution as defined in claim 1, wherein the plating solution comprises 3-10 wt % of an organic acid having at least one sulfonic acid group (—SO₃H), 0.1-15 wt % of a complexing agent, 0.5-5 wt % of a thio-compound having at least one —S—, 0.1-1 wt % of a water soluble gold compound, 0.02-0.2 wt % of a water soluble silver compound and 0.5-5 wt % of a sequestering agent, on the basis of the weight of the plating solution.

3. The plating solution as defined in claim 1, wherein said organic acid is selected from the group consisting of methane sulfonic acid, methane disulfonic acid, sulfo salicylic acid, phenol, sulfonic acid, amido sulfonic acid, dodecyl benzene sulfonic acid and combinations thereof.

4. The plating solution as defined in claim 1, wherein said complexing agent is selected from the group consisting of cyanides of alkali metals, cyanides of alkali earth metals, potassium ferricyanide, potassium ferrocyanide and combinations thereof.

5. The plating solution as defined in claim 1, wherein said thio-compound is selected from the group consisting of thiourea, alkylthiourea, mercapto compounds, thioglycolic acid, sodium thiocyanide, ammonium thiocyanide and combinations thereof.

6. The plating solution as defined in claim 1, wherein said water soluble gold compound is selected from the group consisting of potassium gold cyanide, potassium gold chloride and combinations thereof.

7. The plating solution as defined in claim 1, wherein said water soluble silver compound is selected from the group consisting of silver nitrate, silver cyanide, potassium silver cyanide, silver acetate, silver carbonate and combinations thereof.

8. The plating solution as defined in claim 1, wherein said sequestering agent is selected from the group consisting of polycarboxylic acid derivatives, amino acetic acid derivatives, nitrilo-triacetic acid derivatives, and the combinations thereof.

9. The plating solution as defined in claim 8, wherein said sequestering agent is selected from the group consisting of ethylene diamine tetra acetic acid, diethylene triamine penta-acetic acid, N-hydroxyethylethylene diamine triacetic acid, 1,3-diamino-2-propanol-N,N,N,N′-tetra acetic acid, bishydroxyphenyl-ethylene, diamine diacetic acid, N,N-di(hydroxyethyl) glycine, and combinations thereof.

10. The plating solution as defined in claim 1, wherein the content of said water soluble silver compound is 3-8 wt % of the content of said water soluble gold compound.

11. The plating solution as defined in claim 1, wherein a molar ratio of the total gold and silver ions versus the cyanide of the complexing agent is in the range of from 1:1-1:5.

12. The plating solution as defined in claim 1, wherein the plating solution has pH 3-7.

13. A method for plating the modular printed circuit board, comprising the steps of:
a) providing a modular printed circuit board formed with predetermined circuit patterns, having a pad portion for mounting parts and a tab portion for electrically connecting to an exterior device;
b) forming a photo solder resist layer to the remaining portions exclusive of the pad portion and the tab portion in the printed circuit board;
c) forming an electroless nickel plated layer on the pad portion and the tab portion; and
d) immersing the surface of the nickel plated layer in the aqueous electroless plating solution of any one of claims 1 to 12, to form a gold-silver alloy plated layer on the nickel plated layer.

14. The method as defined in claim 13, wherein said gold-silver alloy plated layer comprises 90-99% gold and 1-10% silver.

15. The method as defined in claim 13, wherein said gold-silver alloy plated layer is 0.01-0.25 μm thick.

16. The method as defined in claim 13, wherein said step d) is performed for 5-15 minutes.

17. The method as defined in claim 13, wherein temperature of the aqueous electroless plating solution ranges within 60-90° C. in said step d).
